(19) United States
(12) Patent Application Publication
(10) Pub. No.: US 2026/0041270 A1
(43) Pub. Date: Feb. 12, 2026

(54) SYSTEM FOR RECOGNISING CAPSULES IN BEVERAGE DISPENSING MACHINES

(71) Applicant: G.B. PROGETTI S.R.L., Rivanazzano Termi (PV) (IT)

(72) Inventor: Alberto ROLLA, Rivanazzano Terme (PV) (IT)

(21) Appl. No.: 19/100,296

(22) PCT Filed: Jul. 26, 2023
(86) PCT No.: PCT/IB2023/057567

§ 371 Date: Jan. 31, 2025

(30) Foreign Application Priority Data
Aug. 3, 2022 (IT) 102022000016548

(51) Int. Cl. A47J 31/06; A47J 31/36; B65D 85/804

(52) U.S. Cl. CPC A47J 31/0673; A47J 31/0684; A47J 31/3695; B65D 85/8064

(57) ABSTRACT

Described is a system for recognising capsules in beverage dispensing machines, including, in combination, a capsule including a capsule body having a bottom and an upper opening and a dispensing machine comprising at least one capsule holder carriage configured to house at least the bottom or the closed upper opening and a part of the capsule body; one of the end walls of the capsule holder carriage is provided with a channel for dispensing a pressurized fluid towards the capsule and means for piercing the bottom or the opening of the capsule, when housed, located on the end wall; the machine includes a sealing gasket associated with the end wall of the capsule holder carriage to define a first circular or closed annular zone wherein the piercing means and the fluid dispensing channel are positioned, and a second circular or annular zone on the end wall of the capsule holder carriage separated from the first circular or annular zone on the end wall, the capsule has the bottom or the opening provided with at least one surface section with a modified cross section, configured to be coupled, in use, to the profile of the gasket so as to obtain

[symbol]

### TECHNICAL FIELD

This invention relates to a system for recognising capsules in beverage dispensing machines.

The invention also relates to a capsule which can be used with the above-mentioned recognition system.

### BACKGROUND ART

As is known, one of the problems faced by the manufacturers of machines for dispensing hot infusion beverages, such as coffee, and of the capsules linked to the machine is due to the fact that the capsule coffee machine is very often provided on loan for use (that is to say, without the purchase cost), but equally often the user of this machine does not use original capsules from the above-mentioned manufacturer, but capsules of the “cloned” type which are less expensive.

There are prior art so-called anti-counterfeiting systems based, for example, on a reading of an image by means of suitable optical sensors, which detect a simple two-dimensional image printed on the surface of the object to be checked which is then compared with a reference sample image.

In this way it may be very simple to evade the protection, for example by “printing” the surface of the object with the above-mentioned image, or, more simply, by placing an adhesive label containing the above-mentioned image.

Moreover, the optical sensors, which are inevitably expensive, are economically challenging for the electronics which control them, which are not very reliable due to the complexity of this control, due to the inevitable dirt which at some point contaminates the optical part, etc.

### AIM OF THE INVENTION

The aim of the invention is to provide a system for recognising capsules in beverage dispensing machines which overcomes the above-mentioned drawbacks of the prior art.

In particular, the aim of the invention is to provide a system for recognising capsules in beverage dispensing machines which is able to obtain a perfect dispensing of the product only in the presence of a predetermined original capsule.

A further aim of the invention is to provide a combination of capsule and capsule holder carriage which is able to allow the operation of the dispensing machine only with correct housing of the capsule in the machine in such a way as to obtain an optimum dispensing of the product.

Said aims are fully achieved by a system for recognising capsules in beverage dispensing machines and a relative capsule according to the invention as characterised in the appended claims.

### BRIEF DESCRIPTION OF THE DRAWINGS

The main features of the invention will become more apparent from the following detailed description of a preferred, non-limiting embodiment, illustrated purely by way of example in the accompanying drawings, in which:

FIGS. 1 and 2 are schematic perspective views, with some parts cut away, of a system for recognising capsules in beverage dispensing machines, according to the invention, comprising a capsule holder carriage and a capsule; the drawings being two different configurations for pre-housing and completely housing the capsule, respectively;

FIGS. 3 and 4 are perspective views of corresponding and different solutions of capsules forming part of the system according to the invention;

FIGS. 5 to 13 are side views partly in cross section illustrating further and corresponding variant embodiments of the capsules forming part of the system according to the invention;

FIGS. 14 and 15 are perspective views partly in cross section of a variant embodiment of the system according to the invention with a capsule holder carriage and a capsule.

### DETAILED DESCRIPTION OF PREFERRED EMBODIMENTS OF THE INVENTION

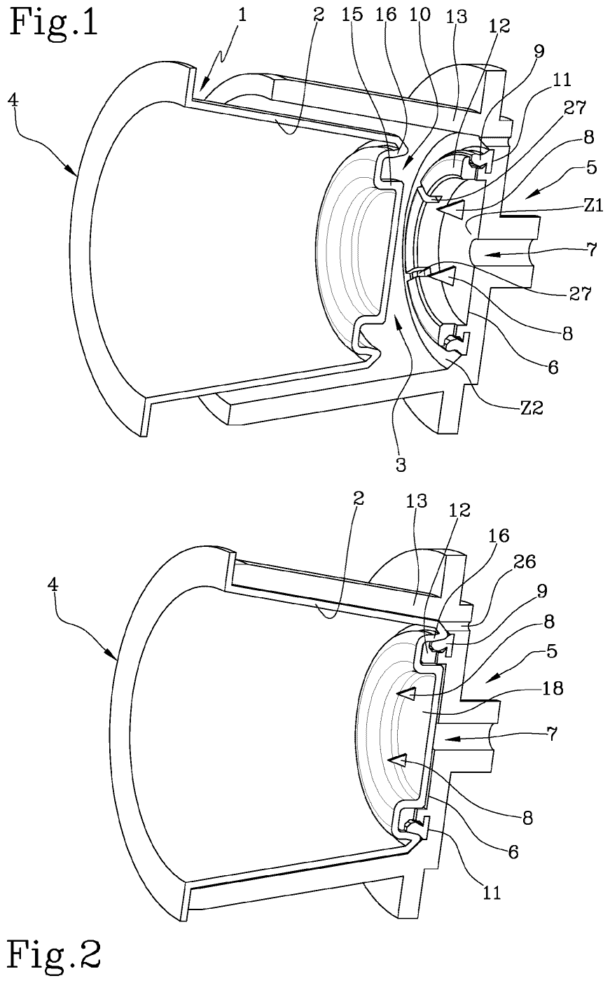

With reference to the accompanying drawings, and with particular reference to FIGS. 1, 2, 14 and 15, the system according to the invention is used in beverage dispensing machines (such as, for example, coffee) using capsules.

The system combines a particular geometry of the capsule holder carriage and of the capsule to distinguish between an original capsule and a cloned capsule.

The system is based on a capsule 1 and a capsule holder carriage 5.

The capsule comprises a capsule body 2 forming a chamber having a bottom 3 and an upper opening 4 on which is positioned a sheet, or a rigid lid that can be pierced, for sealing the chamber containing a dose of product.

The dispensing machine (not illustrated here in its entirety) comprises at least the capsule holder carriage 5 configured to house at least the bottom 3 or the closed upper opening 5 and a part of the capsule body 2.

One of the end walls 6 of the capsule holder carriage 5 is provided with a channel 7 for dispensing a pressurized fluid (water) towards the capsule 1 and means 8 (protruding knives) for piercing the bottom 3 or the opening 4 of the capsule 1, when housed, located (for example, protruding) on the end wall 6.

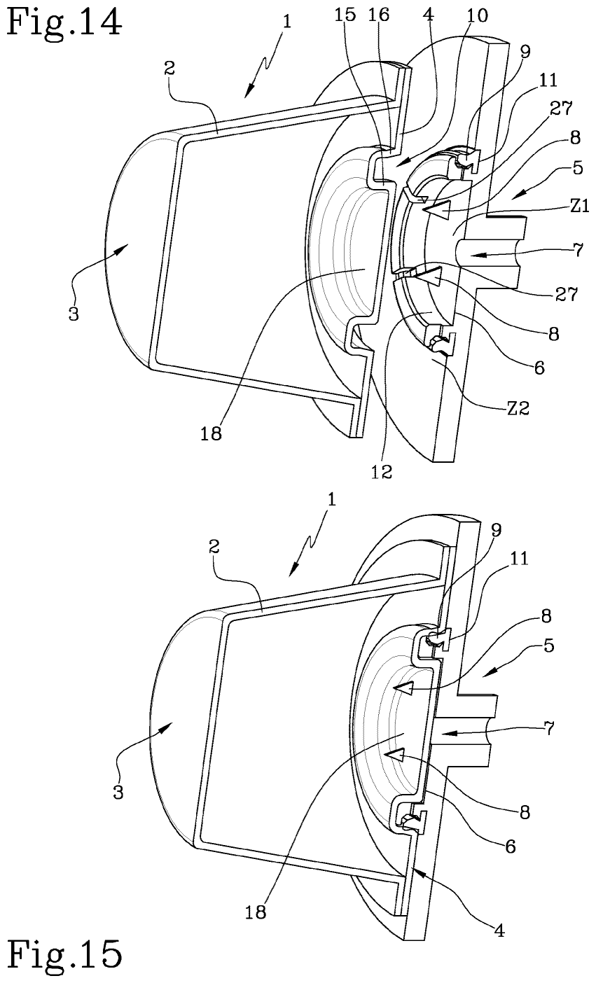

It should be noted that this end wall 6, as a function of the dispensing machine model, can define the bottom of the capsule holder carriage 5 (see FIGS. 1 and 2) or a top wall of the capsule holder carriage 5 (see FIGS. 14 and 15).

As illustrated, the capsule holder carriage 5 comprises a sealing gasket 9 associated with its end wall 6 to define a first circular or closed annular zone Z1 wherein the piercing means 8 and the channel 7 for dispensing the fluid are positioned, and a second circular or annular zone Z2 on the end wall 6 of the capsule holder carriage 5 separated from the first circular or annular zone Z1 on the end wall 6.

Again as illustrated, the system comprises the capsule 1 having the bottom 3 or the opening 4 of the capsule 1 provided with at least a relative stretch surface 10 with a modified cross-section, configured for coupling, in use, to the profile of the sealing gasket 9 so as to obtain a seal to the pressurised fluid entering at least the first circular or annular zone Z1.

It should be noted that in the examples the gasket 9 protrudes from the end wall 6 of the capsule holder carriage 5.

In light of this, the capsule holder carriage 5 comprises a circular seat 11 for housing a first portion of the gasket 9 and a rigid circular wall 12, protruding beyond the gasket 9 and beyond the end wall 6 of the capsule holder carriage 5, for partial separation between the gasket 9 and the first circular or annular zone Z1.

The capsule holder carriage 5 has the second circular or annular portion Z2 of the capsule holder carriage 5 having an inclined section for connecting between the end wall 6 of the body of the capsule holder carriage 5 and an end of a further side wall 13 of the body of the capsule holder carriage 5 (this geometry allows a guide to a correct housing of the opening or of the bottom of the capsule to be obtained).

According to an alternative variant embodiment, not illustrated, the gasket 9 may be positioned recessed in a corresponding hollow seat made on one of the two end walls 6 of the capsule holder carriage 5.

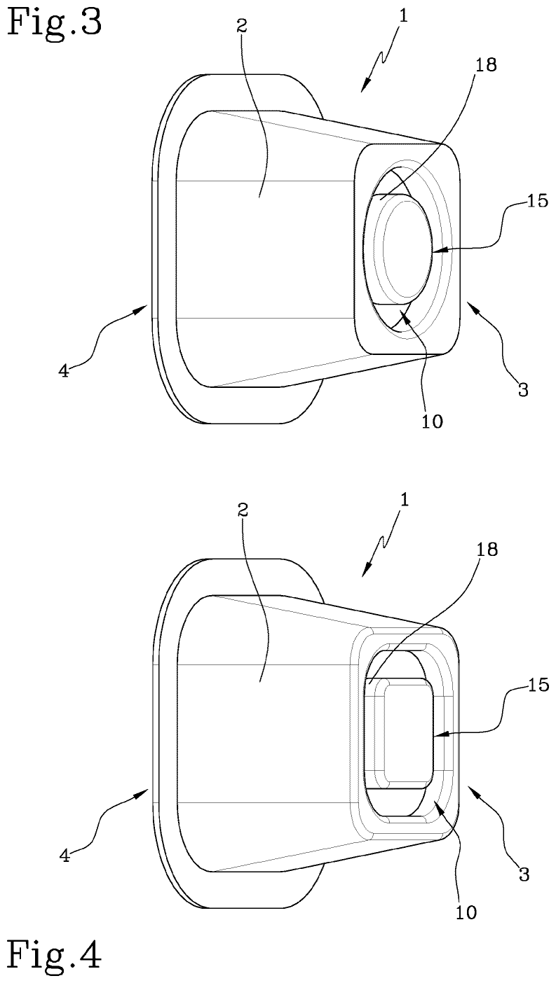

As also illustrated in FIG. 3, the bottom 3 or the opening 4 of the capsule body 2 has the stretch 10 with a modified cross section defined by a circular channel which can be coupled, in use, with the gasket 9.

A first wall 15 forming the channel has a cross section parallel to a longitudinal axis of the capsule in such a way as to delimit a portion of the bottom 3 or of the opening 4 which, in use, can be housed in the first circular or annular zone Z1.

In light of this, the channel has a second wall 16 with a cross section diverging towards the outside in such a way as to be interposed, in use, between a portion of the gasket 9 and the second circular or annular zone Z2 in such a way as to obtain the seal between the capsule 1 and the walls 6, 13 of the capsule holder carriage 5.

According to some variant embodiments illustrated in FIGS. 6, 7, 12 and 13, the capsule 1 may have the bottom 3 or the opening 5 of the capsule body 2 having the stretch 10 with a modified cross section defined by a circular wall 17 protruding from the remaining surface and which can be coupled, at least partly, inside the first circular or annular zone Z1 of the end wall 6 of the capsule holder carriage 5.

As illustrated in FIGS. 1-4, 8, 10 and 13, the bottom 3 or the opening 4 of the capsule 1 has the stretch 10 with a modified cross section configured to define both a sealing channel interacting with the gasket 9 and a centring wall 18 made along and inside the sealing channel.

This centring wall 18 can be coupled, in use, with a relative projection or recess of the seat defined by the sealing gasket 9 made on the capsule holder carriage 5 (that is, in the first circular or annular zone Z1) so as to obtain the centring of the capsule 1 in the capsule holder carriage 5.

On the basis of this concept, see FIG. 3, the capsule 1 has a capsule body 2 with a polygonal cross section with the bottom 3 or the opening 4 provided with a sealing channel and a centring wall 18 with a circular shape.

Alternatively, see FIG. 4, the capsule 1 may have a capsule body 2 with a polygonal cross section with the bottom 3 or the opening 4 provided with a sealing channel and a centring wall 18 with a polygonal shape designed to couple with a polygonal profile of the capsule holder carriage 5.

According to a further geometrical combination, the capsule 1 may have a capsule body 2 with a polygonal cross section with the bottom 3 or the opening 4 provided with a sealing channel with a circular extension and a centring wall 18 with a polygonal shape designed to couple with a polygonal profile of the capsule holder carriage 5 or vice versa.

In short, the system allows discrimination of the capsules 1 based on the stretch 10 of modified cross-section made on the opening or on the bottom of the capsule body 2, (stretch illustrated in FIGS. 1 to 15), with cylindrical and/or preferably truncated cone, or polygonal and preferably flared, surface (to facilitate entry of the sealing gasket), the stretch obtained recessed in the opening or bottom (FIGS. 1-5 and 7-12), or protruding from the opening or bottom (FIGS. 6, 12 and 13), for entrance of water of the capsule 1.

The stretch 10 is coupled to a corresponding sealing gasket 9 housed on the capsule holder carriage 5 forming part of the dispensing “unit” mounted on the dispensing machine.

Since, as illustrated in the accompanying drawings, several possible practical embodiments are based on the same identical principle, for simplicity of description reference will always be made to the case illustrated in FIGS. 1 and 2.

As shown in FIG. 2, with the capsule inserted, the water supplied at the inlet 7 of the carriage 5, passing through the gap between the zone for piercing the capsule 1 and the corresponding first circular or annular zone Z1 of the carriage 5, reaches the piercing means or knives 8 which, by cutting corresponding slits in the piercing zone, allow the water to enter inside the capsule 1.

Along the entire first circular zone Z1 the water is lastly retained by the sealing gasket 9 without being able to pass beyond it and therefore without, as desired, the possibility of escape.

It should be noted that the above-mentioned stretch 10 can also define a centring wall 18, opposite the sealing wall 15. This wall 18, if present, may be a valid aid for centring a capsule 1 in the capsule holder carriage 3 at the moment of entry with the sealing gasket 9.

It should be noted that the pressure in the various zones and gaps mentioned is practically equal to that inside the capsule, without therefore causing forces and deformations inside the capsule. Only downstream of the seal, in a gap 26 in communication with the outside (by means of one or more holes) will the pressure be atmospheric pressure, but this, given the small surface of the capsule affected by this pressure jump will not generate any problem and, on the contrary, by pressing on the gasket, it will increase the seal. The truncated cone lateral wall will, on the other hand, press without problems against the inside of the capsule holder carriage 5.

Now, with the use of a capsule which does not conform with the flat bottom, even if the capsule were also pressed with a certain force, it would not reach the piercing knives and, in any case, without the sealing wall made on the bottom of the capsule, there would be a direct escape towards the outside of the water supplied, through the one or more holes of the gap 26 which are in communication with the outside.

It should be noted that a flat capsule base pressed on the seat 11 of the sealing gasket 9 would not achieve any sealing effect due to cuts 27 (clearly visible in FIG. 1) present on the protruding surface 12 of the seat 11 made on the end wall 6 of the carriage 5.

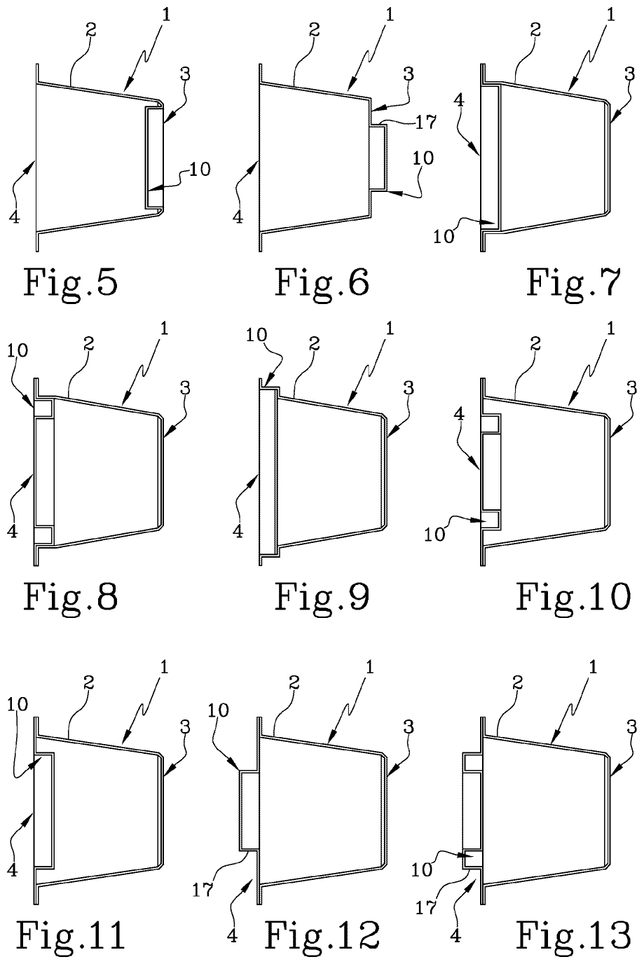

A series of embodiments of the capsule are illustrated which can be used in FIGS. 5 to 13 and which will not be commented on since they are evident.

It should be noted (FIGS. 1-4, 8, 10, 13) that where the stretch 10 defines both a sealing wall 15 and a centring wall 18, the respective functions can be exchanged with each other, obviously forming on a capsule holder carriage 5 a suitable sealing gasket 9 housed in a respective suitable seat 11.

In all the FIGS. 5 to 13 the sealing walls or faces 15 have been schematically shown without an inclination, that is to say, parallel to the axis of symmetry of a respective capsule, but, preferably, the outermost part will have a predetermined divergence to facilitate the entrance of a gasket 9, as shown in FIGS. 1 and 2.

Generically, for simplicity, the capsules have been shown with the outer side surface of the capsule body 2 with a circular shape, but (see FIGS. 3 and 4) they may have any generic polygonal shape. In this case, a sealing wall 15 and/or, if necessary, a centring wall 18 may have a circular shape (FIG. 3) or be polygonal (FIG. 4), with an axis of symmetry coinciding with that of the capsule.

Obviously, a sealing gasket 9 and a relative seat on the capsule holder carriage 5 must copy the selected profile.

Obviously, also in the case of a capsule 1 made with an outer surface of the capsule body 2 with a polygonal cross-section (FIG. 3) there will be all the same possible embodiments of the circular sealing walls 15 and, if necessary, centring walls 18 seen in FIGS. 5 to 13, or similar to the same in the case of sealing walls 15 and/or centring walls 18 made with a polygonal profile, as in the case illustrated as an example in FIG. 4.

Each capsule illustrated may be sealed without distinction by means of lightweight, flexible top film and a rigid lid which can be pierced.

The capsule solutions shown in FIGS. 7-8 and 10 to 13 only consider the solution with a rigid lid which can be pierced.

It should be noted that, in the absence of the centring wall, the same centring function may be performed by one or more stretches, cylindrical and/or polygonal not tapered in the case of polygonal capsules, of the capsule body, obviously copied from the inner profile of the capsule holder.

Obviously, all the solutions proposed can be made without distinction with both traditional materials and with today's and innovative biodegradable and/or compostable materials.

1. A system for recognising capsules in beverage dispensing machines, a capsule comprising a capsule body forming a chamber having a bottom and an upper opening on which is positioned a sheet, or a rigid lid that can be pierced, for sealing the chamber containing a dose of product; said dispensing machine comprising at least one capsule holder carriage configured to house at least the bottom or the closed upper opening and a part of the capsule body; one of the end walls of the capsule holder carriage being provided with a channel for dispensing a pressurised fluid towards the capsule and means for piercing the bottom or the opening of the capsule, when housed, positioned on the end wall, characterised in that the capsule holder carriage comprises a sealing gasket associated with its end wall to define a first circular or closed annular zone wherein the piercing means and the fluid dispensing channel are positioned, and a second circular or annular zone on the end wall of the capsule holder carriage separated from the first circular or annular zone on the end wall, and in that the capsule has the bottom or the opening provided with at least one surface section with a modified cross section, configured to be coupled, in use, to the profile of the gasket so as to obtain a seal for the pressurised fluid entering at least in the first circular or annular zone.

2. The system according to claim 1, wherein the gasket protrudes from the end wall of the capsule holder carriage; the capsule holder carriage comprises a circular seat for housing a first portion of the gasket and a rigid circular wall, protruding beyond the gasket and beyond the end wall of the capsule holder carriage, for partial separation between the gasket and the first circular or annular zone.

3. The system according to claim 1, wherein the second circular or annular portion of the capsule holder carriage has an inclined section for connecting between the end wall of the body of the capsule holder carriage and an end of a further side wall of the body of the capsule holder carriage.

4. The system according to claim 1, wherein the seal is positioned recessed in a corresponding hollow seat formed on one of the two end walls of the capsule holder carriage.

5. The system according to claim 1, wherein the bottom or the opening of the capsule body has the stretch with a modified cross section defined by a circular channel which can be coupled, in use, with the gasket; a first wall of the channel having a cylindrical cross section in such a way as to delimit a portion of the bottom or of the opening which, in use, can be housed in the first circular or annular zone; the channel having a second wall with a frustoconical cross section diverging towards the outside in such a way as to be interposed, in use, between a portion of the gasket and the second circular or annular zone in such a way as to obtain, by contact with the gasket, the seal between the capsule and the walls (6, 13) of the capsule holder carriage.

6. The system according to claim 1, wherein the bottom or the opening of the capsule body has the stretch with a modified cross section defined by a circular wall protruding from the remaining surface and which can be coupled, at least partly, inside the first circular or annular zone of the end wall of the capsule holder carriage.

7. The system according to claim 1, wherein the bottom or the opening of the capsule has the stretch with a modified cross section configured to define both a sealing channel interacting with the gasket and a centring wall made along and inside the sealing channel; said centring wall being designed to be coupled, in use, in the first circular or annular zone and in such a way as to centre the capsule in the capsule holder carriage.

8. The system according to claim 7, wherein the capsule has a capsule body with a polygonal cross section and having the bottom or the opening provided with a sealing channel and a centring wall with a circular shape.

9. The system according to claim 7, wherein the capsule has a capsule body with a polygonal cross section and having the bottom or the opening provided with a sealing channel and a centring wall with a polygonal shape designed to couple with a polygonal profile of the capsule holder carriage.

10. The system according to claim 7, wherein the capsule has a capsule body with a polygonal cross section and having the bottom or the mouth provided with a sealing channel with a circular extension and a centring wall with a polygonal shape designed to couple with a polygonal profile of the capsule holder carriage or vice versa.
